(19) United States
(12) Patent Application Publication
(10) Pub. No.: US 2008/0178423 A1
(43) Pub. Date: Jul. 31, 2008

(54) Hookfree curtain and fixture thereof

(76) Inventor: Niranjan Patel, Edison, NJ (US)

Correspondence Address: AHSAN & ASSOCIATES, P.O. BOX 251, HOPEWELL JUNCTION, NY, 12533, US

(21) Appl. No.: 11/639,981

(22) Filed: Dec. 15, 2006

(51) Int. Cl. E05D 15/12

(52) U.S. Cl. 16/87.2

(57) ABSTRACT

The present invention relates to a hookfree curtain and fixture thereof. More particularly, the invention encompasses a hookfree shower curtain that can be used in the motel/hotel industry. This invention further includes inventive features, such as, a snap-on or clip-on curtain fixture or module or ring which is either a single piece or a two piece module that is secure to a curtain and allows the curtain, such as, a shower curtain, to be slideably secured to a rod, such as, a shower rod, without having to disassemble the rod, such as the shower rod.

### FIELD OF THE INVENTION

The present invention relates to a hookfree curtain and fixture thereof. More particularly, the invention encompasses a hookfree shower curtain that can be used in the motel/hotel industry. This invention further includes inventive features, such as, a snap-on or clip-on curtain fixture or module or ring which is either a single piece or a two piece module that is secure to a curtain and allows the curtain, such as, a shower curtain, to be slideably secured to a rod, such as, a shower rod, without having to disassemble the rod, such as the shower rod.

### BACKGROUND INFORMATION

There are many types of curtains and associated curtain hardware along with various types of rods and other fixtures that are used to hang these curtains, and each of them have some drawback, such as the need to assemble or disassemble the curtain, or the need to assemble or disassemble the rod or associated fixtures.

The wide spread use of curtains and the like, such as, drapes and portieres, by consumers and businesses are for many aesthetic and practical reasons. In a home, it is convenient to separate one portion of a room from another, such as, by using a curtain, such as, a shower curtain. Window curtains and drapes are also used to beautify homes as well as for privacy. For similar reasons they are also used by businesses and at other venues. It is also common to use a curtain type arrangement to separate one room from another room. Curtains are also used in manufacturing facilities or by businesses to separate or define areas.

One of the common elements to curtains, drapes and the like is that they are usually mounted onto a rod and the intended use requires the mounting to allow movement of the curtain or at least portions of the curtain along the rod. Typical, the rod has a uniform cross section, usually circular.

In many situations, the curtains are not mounted directly onto the rod. Instead, rings or clips are used to connect portions of a curtain to a rod. For example, a typical shower curtain may require about a dozen clips and each clip must be manually attached to both the shower curtain and the rod.

It is also a common practice to have relatively small window drapes and the like include a sewn potion to define a tubular portion near one end of the material for mounting onto a rod. In such situations the rod must be removed from its mounting on the wall or window and threaded through the tubular portion.

Another arrangement for attaching curtains and the like to rods uses a plurality of clips or needle-like hardware which penetrates into a portion of the curtain to attach to the curtain and another portion of each clip or hardware is then attached either directly to the rod or to rings attached to the rod.

Furthermore, U.S. Pat. No. 5,186,232 (Zahner) discloses an invention that relates to an accessory suitable for mounting onto a rod to support a piece of material, and more particularly to an accessory which can take the form of a curtain, drape or portiere.

U.S. Pat. No. 6,189,597 (Cheng) discloses an invention that relates to a curtain with a hanger ring assembly for mounting onto a supporting rod which includes a sheet material and a plurality of hanger units. The sheet material has a plurality of hanger openings formed along a top edge, and a plurality of edge gap each extending from the top edge to an upper portion of the respective hanger opening. Each of the hanger units includes a hanger ring which has a ring slit separating two ends thereof and defines a section of ring tab adjacent to the ring slit. Each of the hanger rings is attached to one side of the respective opening portion and coaxially extended around the respective hanger opening with the ring slit of the respective hanger ring staggering with the edge gap of the respective opening portion. The connecting tabs of the opening portions of the sheet material are detachably overlapped with the ring tabs of the hanger rings respectively. Each of the hanger units further includes a connecting device for selectively connecting each of the ring tabs with the respective connecting tab. Accordingly, the hanger ring assembly not only enables the curtain to be directly mounted onto a supporting rod without the need of additional hook or clip members nor the need of taking down the rod, but also prevents any cuts between the hanger openings on the curtain.

U.S. Pat. No. 6,494,248 (Zahner) discloses an invention that relates to a hanging material such as a curtain is provided with openings each having a slit therein for attachment to a fixed rod. Each opening is reinforced with rings having projecting flanges extending beyond the ring away from the curtain. The projecting flanges of the rings makes it easier to open up the ring thereby facilitating the placement of the curtain upon the fixed rod.

U.S. Pat. No. 6,935,402 (Zahner) discloses an invention that relates to hanging products having an opening for suspending the item from a rod without removing the rod from its mounted supports.

However, the present invention overcomes the difficulty in the prior art by easily attaching a curtain or the like to a rod without the necessity of threading the rod or the use of supporting clips or needles or additional hardware while maintaining an attractive appearance to the mounted curtain.

Accordingly, it can be seen that a need exists for a simple and effective hookfree fixture for attaching a curtain or the like to a rod.

### Purposes and Summary of the Invention

The invention is a hookfree curtain and fixture thereof.

Therefore, one purpose of this invention is to provide a hookfree curtain having at least one hookfree fixture or module or hookfree snap-on or clip-on fixture or module.

Another purpose of this invention is to provide a hookfree shower curtain having at least one hookfree fixture or module.

Yet another purpose of this invention is to provide a hookfree shower curtain having at least one hookfree fixture or module that is secured to a shower rod.

Therefore, in one aspect this invention comprises a hookfree curtain fixture, comprising a male portion and a female portion, wherein said male portion has a male tab portion to accommodate at least one protruding tab, and said female portion has a female tab portion having at least one opening to accommodate said at least one protruding tab from said male tab portion, said male portion further having a plurality of protruding tabs and said female portion having a plurality of openings to accommodate said plurality of protruding tabs, and wherein said male portion has at least one channel opening and said female portion has at least one channel opening, such that when said male portion is secured to said female portion at least a portion of said channel opening in said female portion is overlapped by at least a portion of said male tab portion, and at least portion of the said channel opening in said male portion is overlapped by at least a portion of said female tab portion.

In another aspect this invention comprises a hookfree fixture adapted for being detachably mounted onto a rod-like member, said hookfree fixture comprising a flexible sheet of material having an end portion and mounting means integral with said material near the end portion both for mounting onto and detaching from said rod-like member without the necessity of threading said hookfree fixture onto and off said rod-like member, said mounting means comprising an opening defined in said material, and wherein said hookfree fixture is slide onto said rod-like member and securely snapped into place.

In yet another aspect this invention comprises a hookfree curtain, comprising a curtain having at least one large opening for the insertion of at least one curtain rod, said large opening surrounded by a plurality of first openings, wherein said first openings being substantially equidistant from the center of said large opening and at least one second opening, wherein the distance of said second opening to the center of said large opening is different than the distance of said first opening to the center of said large opening, and wherein at least one channel connects said large opening in said curtain to an edge of said curtain and provides a slit opening.

In still yet another aspect this invention comprises a hookfree fixture, comprising a male portion and a female portion, wherein said male portion has a male tab portion to accommodate at least one offset protruding tab, and said female portion has a female tab portion having at least one offset opening to accommodate said at least one offset protruding tab from said male tab portion, said male portion further having a plurality of paired protruding tabs and said female portion having a plurality of paired openings to accommodate said plurality of corresponding paired protruding tabs, and wherein said male portion has a central opening having a center such that the distance from said center to said offset protruding tab is different than the distance from said center to at least one of said paired protruding tabs, and wherein said female portion has a central opening having a center such that the distance from said center to said offset opening is different than the distance from said center to at least one of said paired openings, and wherein said male portion has at least one channel opening and said female portion has at least one channel opening, such that when said male portion is secured to said female portion at least a portion of said channel opening in said female portion is overlapped by at least a portion of said male tab portion, and at least portion of the said channel opening in said male portion is overlapped by at least a portion of said female tab portion.

### BRIEF DESCRIPTION OF THE DRAWINGS

The features of the invention believed to be novel and the elements characteristic of the invention are set forth with particularity in the appended claims. The drawings are for illustration purposes only and are not drawn to scale. Furthermore, like numbers represent like features in the drawings. The invention itself, however, both as to organization and method of operation, may best be understood by reference to the detailed description which follows taken in conjunction with the accompanying drawings in which:

FIG. 1A is a first embodiment of the invention showing the front view of the male portion of the inventive hookfree fixture.

FIG. 1B is a rear view of the inventive hookfree fixture of FIG. 1A.

FIG. 1C is a side view of the inventive hookfree fixture of FIG. 1A.

FIG. 2A is a first embodiment of the invention showing the front view of the female portion of the inventive hookfree fixture.

FIG. 2B is a rear view of the inventive hookfree fixture of FIG. 2A.

FIG. 2C is a side view of the inventive hookfree fixture of FIG. 2A.

FIG. 3 is second embodiment of the invention showing the inventive hookfree fixture secured to the inventive hookfree curtain and slideably secured onto a rod.

FIG. 4 is a third embodiment of the invention showing the inventive hookfree curtain.

FIG. 5 is a fourth embodiment of the invention showing the male portion of the inventive hookfree fixture attached to the female portion of the inventive hookfree fixture along at least a portion of the edge via at least one connecting tab.

FIG. 6 illustrates an embodiment of the invention showing the inventive living hinge for the inventive hookfree fixture.

### DETAILED DESCRIPTION

The present invention overcomes the disadvantages of the prior art problems by providing a hookfree fixture which can be easily mounted onto and detached from a rod without the necessity of threading the accessory onto and off the rod.

As used herein, the terms “rod” or “rod-like” refers to an elongated object which can have a varying cross-section, but preferably a uniform cross-section and it can be solid or hollow. More preferably, the cross-section is circular. The rod can be made of wood, metal, plastic, a combination of any of the foregoing, or any other suitable material for supporting the inventive hookfree fixture.

The hookfree fixture can be secured to a curtain, drape, portiere, or the like, or an intermediate segment between a rod and another portion, such as, a sheet of material or the like. Accordingly, the sheet of material would be attached to the hookfree fixture either permanently or detachably and the hookfree fixture would be mounted onto the rod.

As used herein, the term “sheet of material” broadly refers to a piece of material having relatively large dimensions in the directions of height, length and width as compared to its thickness. The sheet of material can be made of any substance consistent with the scope of the invention. The invention in a preferred embodiment relates to a hookfree fixture adapted for detachable mounting onto a rod-like member. The “sheet of material” could further include a relatively flexible sheet of material having an end portion and mounting means integral with the material near the end portion both for mounting onto and detaching from the rod-like member without the necessity of threading the hookfree fixture onto and off the rod-like member.

The inventive hookfree fixture further provides reinforcing means integral with the material for each of the openings for inhibiting the tearing of the material and maintaining the integrity of the shape of the openings while engaged on the rod-like member.

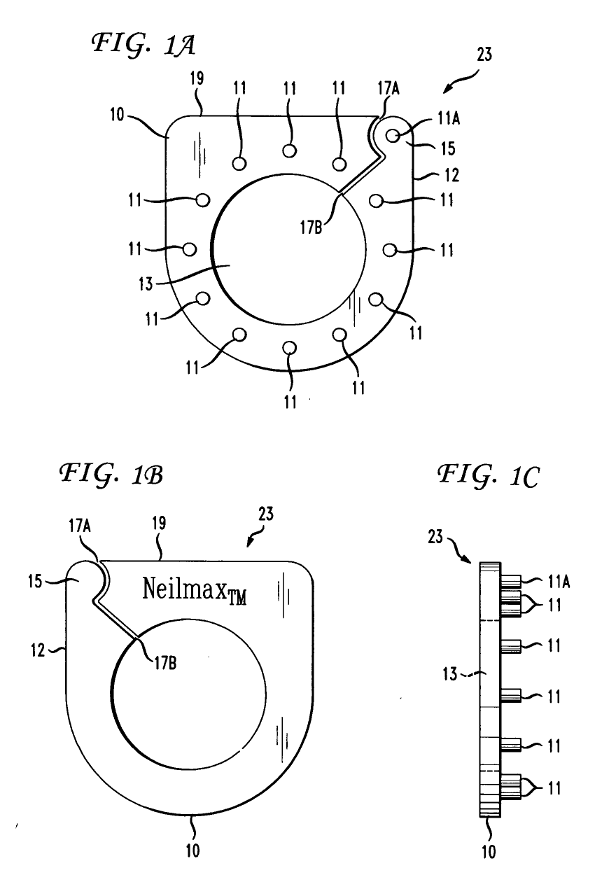

FIG. 1A is a first embodiment of the invention showing the front view of the male portion 10, of the inventive hookfree fixture or module or ring 23. The male portion 10, has at least one offset protruding tab 11A, and a plurality of paired protruding tabs 11. The male portion 10, has a tab portion 15, to accommodate at least one offset protruding tab 11A. The male portion 10, has an opening or a hole 13, and a channel openings 17A and 17B, that allows the tab 15, to move up or down from the plane of the male portion 10, thus providing a living hinge. The channel opening 17A, preferably originates at the outer periphery of the male portion 10, such as an edge 19, and goes around a portion of the offset protruding tab 11A. The channel opening 17B, is preferably a straight channel opening, and it connects the opening 13, to the channel opening 17A. For some applications a portion of the channel opening 17A would have a curvature or be substantially straight, while in other applications a portion of the channel opening 17B would be substantially straight or have a curvature. It should be appreciated that in FIG. 1A, the protruding tab 11A is shown on the surface of the tab 15, while protruding tabs 11 are shown in an almost circular fashion around the periphery of the opening 13, on the surface of the male portion 10, but a person skilled in the art can easily adjust the location, protruding extension, diameter and similar other features of the protruding tabs 11 and 11A. However, it is preferred that the protruding tab 11A, is on the surface of the tab 15, and is in an offsetting position from the other protruding tabs 11. It is preferred that the tab area 15, having the at least one protruding tab 11A, is between an edge 12, and an edge 19, of the male portion 10. The protruding tabs 11 and 11A, have a cross-section that is selected from a group comprising substantially a triangular shape, a rectangular shape, a circular shape, a cylindrical shape, an hour-glass shape, a conical shape, a pyramidal shape, to name a few.

FIG. 1B is a rear view of the inventive hookfree fixture or module 23, of FIG. 1A.

FIG. 1C is a side view of the inventive hookfree fixture or module 23, of FIG. 1A, clearly showing the at least one protruding tab 11A, and a plurality of protruding tabs 11, in the male portion 10.

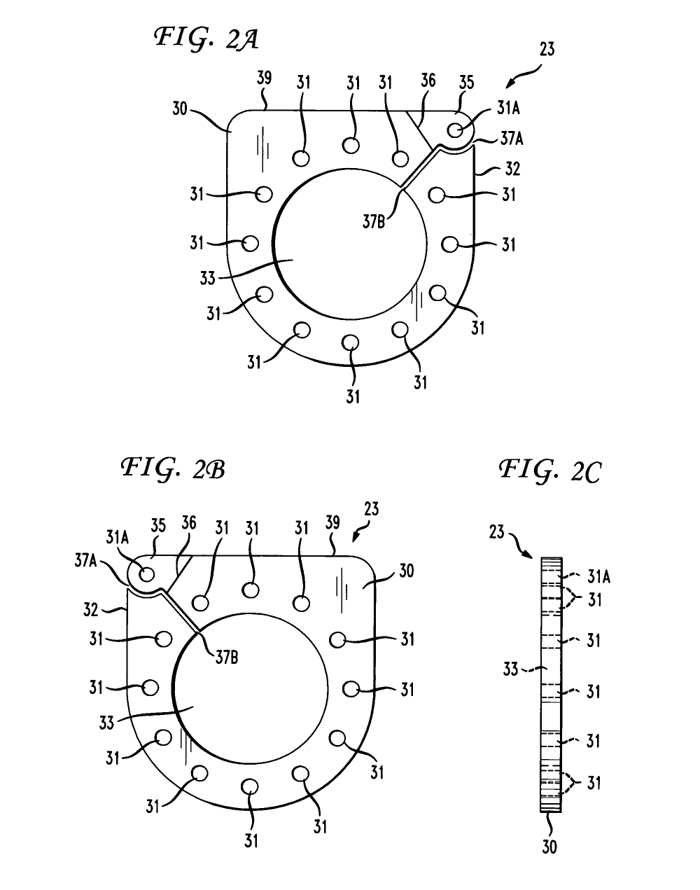

FIG. 2A is a first embodiment of the invention showing the front view of the female portion 30, of the inventive hookfree fixture or module 23. The female portion 30, has at least one offset tab hole or blind hole or opening 31A, to securely accommodate the at least one corresponding offset protruding tab 11A, and a plurality of tab holes or blind holes or paired openings 31, to securely accommodate the corresponding paired protruding tabs 11. The female portion 30, has a tab portion 35, to accommodate at least one tab opening 31A. The female portion 30, has an opening or a hole 33, and a channel openings 37A and 37B, that allows the tab 35, to move up or down from the plane of the female portion 30, thus providing a living hinge 36. There are many ways of creating the optional living hinge 36, one such way would be have a slight weakness along a portion of the tab portion 35, thus allowing the tab 35, to move up and down along a weak portion such as along an edge of the living hinge 36. However, for some applications it is preferred that either the male portion 10, or the female portion 30, or both have a living hinge 36. The channel opening 37A originates at the outer periphery of the female portion 30, and goes around a portion of the tab opening 31A. The channel opening 37B, is preferably a straight channel opening, and it connects the opening 33, to the channel opening 37A. For some applications a portion of the channel opening 37A would have a curvature or be substantially straight, while in other applications a portion of the channel opening 37B would be substantially straight or have a curvature. It should be appreciated that in FIG. 2A, the tabs opening 31A is shown on the surface of the tab 35, while the tab openings 31 are shown in an almost circular fashion around the periphery of the opening 33, on the surface of the female portion 30, but a person skilled in the art can easily adjust the location, opening diameter and similar other features of the tab openings 31 and 31A. However, it is preferred that the tab opening 31A, is on the surface of the tab 35, and is in an offsetting position from the other tabs openings 31. It is preferred that the tab area 35, having the at least one tab opening 31A, is between an edge 32, and an edge 39, of the female portion 30. The cross-section for the tab openings 31 and 31A, have a cross-section that is selected from a group comprising substantially a triangular shape, a rectangular shape, a circular shape, a cylindrical shape, a hour-glass shape, a conical shape, a pyramidal shape, to name a few.

FIG. 2B is a rear view of the inventive hookfree fixture or module 23, of FIG. 2A.

FIG. 2C is a side view of the inventive hookfree fixture or module 23, of FIG. 2A, clearly showing the at least one tab opening 31A, and a plurality of tab openings 31, in the female portion 30.

It should be appreciated that the channels or slits 17A, 17B, 37A and 37B, allow the selective opening and closing for the male member 10 and female member 30, and the sealing of the same via the use of tab members 15 and 35. In fact male member 10 and female member 30, can be securely locked in place upon the insertion of the offset protruding member 11A, into the offset hole 31A, and the insertion of the paired protruding members 11, into the corresponding paired openings 31, and snapping each member in place. In a closed position the hookfree fixture or module 23, securely and snugly holds its content in place while allowing a sliding movement of its secured content along the path of its opening 13 and 33. In one sense the hookfree module provides a ring to its content, which ring can be opened and sealably closed using the male member 10 and the female member 30, such as, the tab portions 15 and 35.

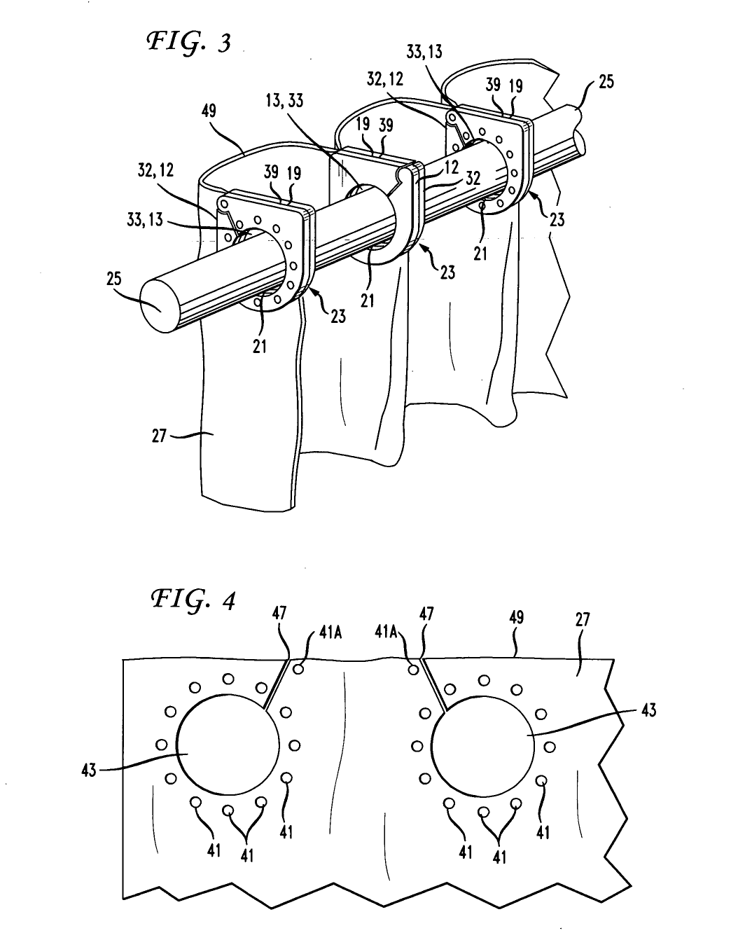

FIG. 3 is second embodiment of the invention showing the inventive hookfree fixture 23, secured to an upper edge 49, of the inventive hookfree curtain 27, and slideably secured to a rod 25. The curtain 27, has a big opening 21, and a plurality of small openings (not shown) to allow the passage of the protruding tabs 11 and 11A, of the male portion 10. It is preferred that the opening 21, in the hookfree curtain 27, is similar in size to the openings 13 and 33, in the male portion 10, and the female portion 30, respectively, so as to easily and slideably accommodate a rod 25, such as, a curtain rod 25, or a shower curtain rod 25.

Once the protruding tabs 11 and 11A, from the male portion 10, are passed through the corresponding openings in the curtain 27, the female portion 30, is then securely attached to the male portion 10, such that the protruding tabs 11 and 11A, pass through the curtain 27, and are securely held in place within the corresponding openings 31 and 31A, in the female portion 30. It should be appreciated that the tab 15, on the male portion 10, and the tab 35, on the female portion 30, are placed in such a way such that at least a portion of the tab 10, overlaps at least a portion of the channel 37A, while at least a portion of the tab 35, overlaps at least a portion of the channel 17A, so as to provide a continuous secured positioning to the curtain 27, which is sandwiched between the male portion 10 and the female portion 30, which is more clearly shown in FIG. 4. It should also be understood that the channel openings 17B and 37B may or may not overlap but that may not create a security problem as the overlapping of the tabs 15 and 35, provide an excellent security to the inventive hookfree curtain 27, once the protruding tab 11A is securely snapped into the corresponding opening 31A.

FIG. 4 is a third embodiment of the invention showing the inventive hookfree curtain 27. The hookfree curtain 27, has at least one large opening or hole 43, to substantially correspond to the openings 13, in the male portion 10, and the opening 33, in the female portion 30. The opening 43, is further surrounded by a plurality of holes or openings 41, that substantially correspond to the protruding tabs 11, in the male portion 10, so as to allow the passage of the protruding tabs 11, to pass there through and mate with corresponding holes or openings 31, in the female portion 30. At least one off-set hole or opening 41A, in the hookfree curtain 27, allows the passage of the corresponding tab 11A, from the male portion 10, to pass there through and connect with the corresponding hole or opening 31A, in the female portion 30. At least one channel 47, provides an opening or channel or a slit or an edge gap in the curtain 27, so as to provide a link between the hole or opening 43, and the outer edge 49, of the curtain 27. At least a portion of the channel opening 17B, is substantially parallel to the channel opening 47. Similarly, at least a portion of the channel opening 37B, is substantially parallel to the channel opening 47. It is preferred that at least a portion of the channel opening 17B, 37B and 47, are at an angle of between about 30 degrees to about 60 degree to the edge of the hookfree curtain 27. However, it is more preferred that at least a portion of the channel opening 17B, 37B and 47, are at a 45 degree angle to the edge of the hookfree curtain 27.

An important feature of this invention is that the male portion 10, has at least one protruding tab 11A which is substantially and distinctly separate from the protruding tabs 11. For example, if the protruding tabs 11, share a common or substantially common distance or radius as taken from the center of the opening 13, then the protruding tab 11A will have a different distance or radius as taken from the center of the opening 13.

Another important feature of this invention is that the female portion 30, has at least one tab opening 31A which is substantially and distinctly separate from the tab openings 31. For example, if the tab openings 31, share a common or substantially common distance or radius as taken from the center of the opening 33, then the tab opening 31A will have a different distance or radius as taken from the center of the opening 33.

Similarly, another important feature of this invention is that the hookfree curtain 27, has at least one opening 41A which is substantially and distinctly separate from the openings 41. For example, if the openings 41, share a common or substantially common distance or radius as taken from the center of the opening 43, then the opening 41A will have a different distance or radius as taken from the center of the opening 43.

As a person skilled in the art can appreciate that this offsetting of the openings 31A and 41A, is to allow the penetration of the corresponding offsetting protruding tab 11A, through these openings 31A and 41A, for a secure installation of the hookfree curtain 27, on the rod 25. Similarly, a person skilled in the art can also appreciate that the openings 31, in the female portion 30, and the openings 41, in the hookfree curtain 27, allow the penetration of the corresponding protruding tabs 11, from the male portion 10, to pass through these openings 31 and 41, for a secure installation of the male portion 10, to the female portion 30, through the curtain 27. As a person skilled in the art can also appreciate that channels 17A, 17B, 47, 37A and 37B, allow the sliding of a curtain rod 25, therethrough, and then the hookfree fixture 23, can be snapped into place for the secure hanging of the curtain 27, onto a rod 25.

Thus, with this invention there is no need to remove the rod 25, in order to install a curtain 27. There are many ways to install the hookfree curtain 27, onto a rod 25. For example, one way would be to pass the curtain 27, through the channel 47, and onto the rod 25, such that the rod 25, passes through the opening 43. The next step would be to pass the protruding tabs 11, 11A, through the corresponding openings 41, in the curtain 27, such that the rod 25, passes through the opening 13, in the male portion 10. The final step would be to snap and secure the female portion 30, to the male portion 10, by snapping the protruding tabs 11 and 11A, inside the corresponding openings 31 and 31A, in the female portion 30. It should be appreciated that the living hinge portion or the tab portions 15 and 35, having the offsetting protruding tab 11A, and the corresponding offsetting opening 31A, respectively, overlap the edge gap 47, thus preventing the curtain 27, or the hookfree fixture 23, from sliding off from the rod 25.

It is preferred that the living hinge, such as, the living hinge 36, is at an angle of between about 30 degrees to about 60 degree to an edge of either the male portion 10, or the female portion 30. However, it is more preferred that the living hinge, such as, the living hinge 36, is at a 45 degree angle to the edge of either the male portion 10, or the female portion 30.

It is also preferred that the living hinge, such as, the living hinge 36, is between the protruding tabs 11 and 11A, and thus allows the movement of the tab portion 15, along the edge of the living hinge. Similarly, it is preferred that the living hinge, such as, the living hinge 36, is between the tabs openings 31 and 31A, and thus allows the movement of the tab portion 35, along the edge of the living hinge.

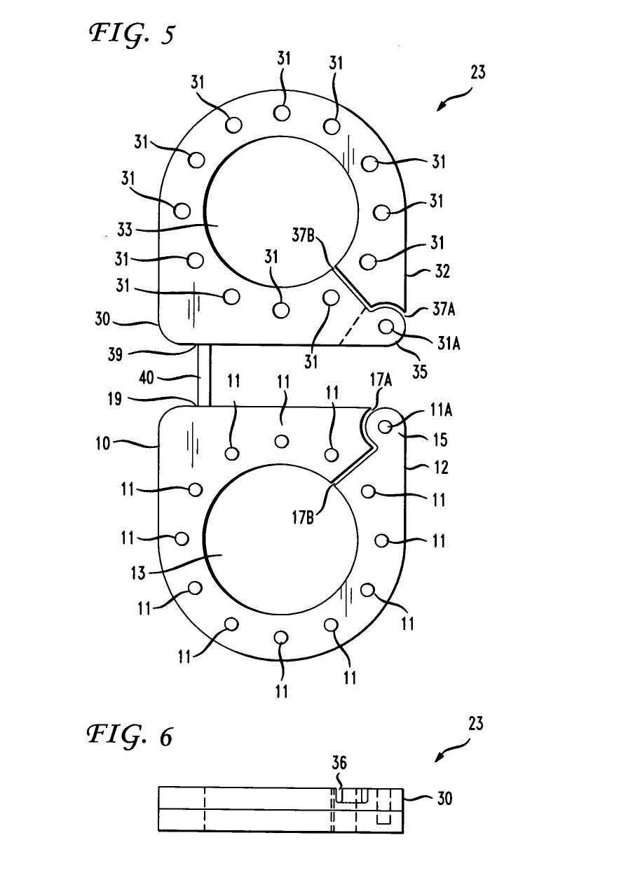

FIG. 5 is a fourth embodiment of the invention showing the male portion 10, of the inventive hookfree fixture 23, attached to the female portion 30, of the inventive hookfree fixture 23, along at least a portion of the edge via at least one connecting tab 40. It should be appreciated that only one connecting tab 40, is shown, however, it is within the realm of the invention to have a plurality of tabs 40, along an edge or to have one large tab 40, or to have a tab 40, in such a way so as to have an edge-to-edge connection of the male portion 10, and the female portion 30, of the inventive hookfree fixture 23.

FIG. 6 illustrates an embodiment of the invention showing the inventive living hinge 36, for the inventive hookfree fixture 23, as it appears in the female portion 30. It is within the realm of a person in the art to know that the living hinge 36, can have any shape, however, it is preferred that the shape of the living hinge 36, is selected from a group comprising substantially of a triangular shape, a rectangular shape, a semicircular shape, a semi-cylindrical shape, a conical shape, a trough-type shape, a weak spot, a plurality of indentations, to name a few.

The material of the inventive hookfree fixture 23, is preferably selected from a group comprising a plastic material, a vinyl material, a metallic material, a rubber material, a composite material, a recycled material, a recyclable material, a hydrophobic material and a Teflon-type or polytetrafluoroethylene-type material, to name a few.

Furthermore, the material for the inventive hookfree fixture 23, could also be selected from a group comprising of opaque material, transparent material, translucent material, to name a few.

Similarly, the material for the inventive hookfree curtain 27, could also be selected from a group comprising of opaque material, transparent material, translucent material, pleated material, to name a few.

The curtain 27, could be selected from a group comprising of a shower curtain, a privacy curtain, a window treatment, a blind, a shade, a drapery, a portiere, a room divider, a windscreen and a window curtain, to name a few.

Furthermore, the material for the hookfree curtain 27, could be selected from a group comprising of a cloth material, plastic material, a vinyl material, a polyester material, a polyester-type material, a polypropylene material, a polypropylene-type material, a metallic material, a rubber material, a composite material, a recycled material, a recyclable material, a hydrophobic material, a Teflon material, a paper material, a disposable-type material, a metallic foil-type material, to name a few. This is especially important when this inventive curtain 27, is used in a field environment, such as, setting up a showering facilities in a remote area, or setting up a field operation during a natural catastrophe, such as, during an earthquake relief efforts, or in a war zone where field hospitals are being set-up quickly and there is a need to provide privacy to the injured people.

The inventive hookfree sheet or curtain 27, can also be made of a plastic or resin, such as commonly used for shower curtains, or a woven fabric or the like, or a non-woven fabric or the like, or a water resistant paper, or sheet metal, or woven metal strands or rods, or some other material suitable for the practice of the invention.

An advantage of using a relatively inexpensive material, such as, a water resistant paper or the like is that the hookfree curtain 27, can be manufactured at a price enabling it to be sold as a disposable curtain. For example, the hookfree curtain 27, can be a disposable shower curtain. A disposable shower curtain could be used in many commercial situations, such as, hotels and motels, and could also be used in other institutional environments.

It should be appreciated that a portion of the hookfree fixture 23, may be visible after the curtain has been mounted. Thus, for some applications the hookfree fixture 23, may have to be provided with some aesthetic appeal to compensate for the necessity of having it exposed.

It is within the realm of this invention to provide the inventive curtain 27, with antibacterial treatment so as to kill most surface germs and to prevent the formation of mold or mildew.

It should be appreciated that Hookfree is a trademark of Neilmax Industries, Inc. and is available on the Internet from their website www.neilmax.com.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A hookfree fixture, comprising a male portion and a female portion, wherein said male portion has a male tab portion to accommodate at least one offset protruding tab, and said female portion has a female tab portion having at least one offset opening to accommodate said at least one offset protruding tab from said male tab portion, said male portion further having a plurality of paired protruding tabs and said female portion having a plurality of paired openings to accommodate said plurality of corresponding paired protruding tabs, and wherein said male portion has a central opening having a center such that the distance from said center to said offset protruding tab is different than the distance from said center to at least one of said paired protruding tabs, and wherein said female portion has a central opening having a center such that the distance from said center to said offset opening is different than the distance from said center to at least one of said paired openings, and wherein said male portion has at least one channel opening and said female portion has at least one channel opening, such that when said male portion is secured to said female portion at least a portion of said channel opening in said female portion is overlapped by at least a portion of said male tab portion, and at least portion of the said channel opening in said male portion is overlapped by at least a portion of said female tab portion.

2. The hookfree fixture of claim 1, wherein said hookfree fixture further comprises at least one living hinge.

3. The hookfree fixture of claim 1, wherein said hookfree fixture further comprises at least one living hinge, and wherein said living hinge separates said at least one protruding tab from said paired protruding tabs.

4. The hookfree fixture of claim 1, wherein said central opening in said male portion and said female portion allows the accommodation of at least one rod-like fixture.

5. The hookfree fixture of claim 1, wherein material for said hookfree fixture is selected from a group consisting of opaque material, transparent material and translucent material.

6. The hookfree fixture of claim 1, wherein material for said hookfree fixture is selected from a group consisting of a cloth material, plastic material, a vinyl material, a polyester material, a polyester-type material, a polypropylene material, a polypropylene-type material, a metallic material, a rubber material, a composite material, a recycled material, a recyclable material, a hydrophobic material, a Teflon material, a paper material, a disposable-type material and a metallic foil-type material.

7. The hookfree fixture of claim 1, wherein a portion of a curtain is securely sandwiched between said male portion and said female portion.

8. The hookfree fixture of claim 7, wherein said curtain is selected from a group consisting of a shower curtain, a privacy curtain, a window treatment, a blind, a shade, a drapery, a portiere, a room divider, a windscreen and a window curtain.

9. The hookfree fixture of claim 7, wherein material for said curtain is selected from a group consisting of a cloth material, plastic material, a vinyl material, a polyester material, a polyester-type material, a polypropylene material, a polypropylene-type material, a metallic material, a rubber material, a composite material, a recycled material, a recyclable material, a hydrophobic material, a Teflon material, a paper material, a disposable-type material and a metallic foil-type material.

10. The hookfree fixture of claim 7, wherein material for said curtain is selected from a group consisting of opaque material, transparent material, translucent material and pleated material.

11. The hookfree fixture of claim 1, wherein the cross-section of at least one of said protruding tab is selected from a group consisting substantially of a triangular shape, a rectangular shape, a circular shape, a cylindrical shape, a hour-glass shape, a conical shape and a pyramidal shape.

12. The hookfree fixture of claim 1, wherein at least one connecting tab securely connects at least a portion of an edge of a said male portion to a corresponding edge of said female portion.

13. The hookfree fixture of claim 1, wherein said hookfree fixture is secured to a sheet of material.

14. The hookfree fixture of claim 1, wherein said hookfree fixture is secured to a sheet of material, and wherein said sheet of material is selected from a group consisting of a curtain, a drape and a portiere.

15. The hookfree fixture of claim 1, wherein said hookfree fixture further comprises connecting means for connecting said hookfree fixture to another component to create a relatively larger unit suitable for mounting onto and detaching from a rod-like member.

16. The hookfree fixture of claim 1, wherein said hookfree fixture further comprises at least one reinforcing means for inhibiting tearing of a material secured to said hookfree fixture.

17. A hookfree fixture adapted for being detachably mounted onto a rod-like member, said hookfree fixture comprising a male portion and a female portion, said male portion having a plurality of protruding tabs and said female portion having a plurality of corresponding holes to accommodate said plurality of protruding tabs, said male portion having at least one opening and a channel opening connecting said at least one opening to an outer edge of said male portion, and said female portion having at least one opening and a channel opening connecting said at least one opening to an outer edge of said female portion, said hookfree fixture further comprising at least one flexible sheet of material having an end portion and mounting means integral with said material near the end portion both for mounting onto and detaching from said rod-like member without the necessity of threading said hookfree fixture onto and off said rod-like member, said mounting means comprising an opening defined in said material, and wherein said hookfree fixture is slide onto said rod-like member and securely snapped into place by snapping said plurality of protruding tabs into said plurality of corresponding holes.

18. A hookfree curtain, comprising a curtain having at least one large opening for the insertion of at least one curtain rod, said large opening surrounded by a plurality of first openings, wherein said first openings being substantially equidistant from the center of said large opening and at least one second opening, wherein the distance of said second opening to the center of said large opening is different than the distance of said first opening to the center of said large opening, and wherein at least one channel connects said large opening in said curtain to an edge of said curtain and provides a slit opening.

19. The hookfree curtain of claim 18, wherein the material for said hookfree curtain is selected from a group consisting of a cloth material, plastic material, a vinyl material, a polyester material, a polyester-type material, a polypropylene material, a polypropylene-type material, a metallic material, a rubber material, a composite material, a recycled material, a recyclable material, a hydrophobic material, a Teflon material, a paper material, a disposable-type material and a metallic foil-type material.

20. The hookfree curtain of claim 18, wherein said channel has an angle of between about 30 degrees to about 60 degree to an edge of said hookfree curtain, and more preferably said channel is at an angle of about 45 degree to an edge of said hookfree curtain.
